(19) United States
(12) Patent Application Publication
(10) Pub. No.: US 2026/0310024 A1
(43) Pub. Date: Oct. 8, 2026

(54) BACKLIGHT MODULE AND DISPLAY APPARATUS

(71) Applicants: BOE MLED TECHNOLOGY CO., LTD., Beijing (CN); BOE TECHNOLOGY GROUP CO., LTD., Beijing (CN)

(72) Inventors: Jiwei SUN, Beijing (CN); Qi QI, Beijing (CN); Hongli ZHU, Beijing (CN); Zeyu SONG, Beijing (CN); Yubiao LI, Beijing (CN); Hui ZHENG, Beijing (CN); Jing CHU, Beijing (CN); Chi WEI, Beijing (CN); Jiangbo YU, Beijing (CN); Yue QIU, Beijing (CN)

(21) Appl. No.: 18/881,961

(22) PCT Filed: May 14, 2024
(86) PCT No.: PCT/CN2024/093042

§ 371 Date: Jan. 7, 2025

(30) Foreign Application Priority Data
Jun. 29, 2023 (CN) 202310787698.5

(51) Int. Cl. G02F 1/13357

(52) U.S. Cl. CPC G02F 1/133608; G02F 1/133603; G02F 1/133606; G02F 1/133611; G02F 1/133621

(57) ABSTRACT

A backlight module and a display device including the backlight module are provided. The backlight module includes: a substrate; an optical layer on the substrate; and a plurality of supporters between the substrate and the optical layer. The optical layer includes a contact area contacting with the plurality of supporters and a non-contact area not contacting with the plurality of supporters, a first distance between the contact area and the substrate is greater than a second distance between the non-contact area and the substrate, and a spacing S between any two adjacent supporters among the plurality of supporters satisfies: S⁴≤K·|\vec{ω}|, where \vec{ω} is a vector, a modulus |\vec{ω}| of the vector is equal to the maximum value of the difference between the first distance and the second distance, and K is a positive number.

### RELATED APPLICATION

This application claims the benefit of Chinese Patent Application No. 202310787698.5 filed on Jun. 29, 2023, the entire disclosure of which is incorporated herein by reference.

### TECHNICAL FIELD

The present disclosure relates to the field of display technology, and in particular, to a backlight module and a display device comprising the backlight module.

### BACKGROUND

The liquid crystal display device is widely used in the display field because of its light weight, good shock resistance, wide viewing angle and high contrast. The liquid crystal display device usually includes a display panel and a backlight, and the display panel is usually arranged at the light emitting side of the backlight to receive light provided by the backlight. The contrast, brightness uniformity and stability of the liquid crystal display device are related to the structure and performance of the backlight. In recent years, Mini light emitting diode (Mini-LED) has been widely concerned because of its excellent performance, and has been applied to the backlight.

### SUMMARY

According to an aspect of the present disclosure, a backlight module is provided, which comprises: a substrate; an optical layer on the substrate; and a plurality of supporters between the substrate and the optical layer. The optical layer comprises a contact area contacting with the plurality of supporters and a non-contact area not contacting with the plurality of supporters, a first distance between the contact area and the substrate is greater than a second distance between the non-contact area and the substrate, and a spacing S between any two adjacent supporters among the plurality of supporters satisfies: S⁴≤K·|\vec{ω}|, where \vec{ω} is a vector, a modulus |\vec{ω}| of the vector is equal to the maximum value of a difference between the first distance and the second distance, and K is a positive number.

In some embodiments,

$$K = \frac{32 \cdot E \cdot {h}_{2}^{3}}{5 \cdot [ ( {ρ}_{1} {h}_{1} + {ρ}_{2} {h}_{2} ) \cdot g \cdot α ]} ,$$

where the optical layer comprises a first optical layer and a second optical layer that are stacked, ρ₁ is a density of the first optical layer and ρ₂ is a density of the second optical layer, h₁ is a thickness of the first optical layer and h₂ is a thickness of the second optical layer, α is a per unit length of the optical layer in a first direction, the first direction is parallel to an x axis of a coordinate system and perpendicular to a thickness direction of the optical layer, E is a Young's modulus of the second optical layer, and g is an acceleration of gravity.

In some embodiments,

$${\to }_{ω} = - \frac{[ ( {ρ}_{1} {h}_{1} + {ρ}_{2} {h}_{2} ) \cdot b \cdot α \cdot g ] \cdot x}{24 \cdot E \cdot {I}_{y}} \cdot ( {L}^{3} - 2 \cdot L \cdot {x}^{2} + {x}^{3} ) ,$$

where the optical layer comprises a first optical layer and a second optical layer that are stacked, ρ₁ is a density of the first optical layer and ρ₂ is a density of the second optical layer, h₁ is a thickness of the first optical layer and h₂ is a thickness of the second optical layer, α is a per unit length of the optical layer in a first direction, the first direction is parallel to an x axis of a coordinate system and perpendicular to a thickness direction of the optical layer, E is a Young's modulus of the second optical layer, g is an acceleration of gravity, b is a width of the optical layer in a second direction, the second direction is parallel to a y axis of the coordinate system and perpendicular to the thickness direction of the optical layer, I_{y} is a moment of inertia of a cross section of the optical layer relative to the y axis, the cross section of the optical layer is perpendicular to a plane where the substrate is located, L is a theoretical spacing between any two adjacent supporters among the plurality of supporters, and x is an arbitrary value between 0 and L.

In some embodiments,

$${I}_{y} = b \cdot \frac{{h}_{2}^{3}}{12} .$$

In some embodiments, the first optical layer comprises a quantum dot film and a composite film, and the second optical layer comprises a diffusion plate.

In some embodiments, S≤245.5 mm.

In some embodiments, a range of |\vec{ω}| is 0~0.35 mm.

In some embodiments, the spacing S between any two adjacent supporters among the plurality of supporters satisfies:

$$S = \frac{{( K \cdot \vert \vec{ω} \vert )}^{\frac{1}{4}}}{2} .$$

In some embodiments, each supporter of the plurality of supporters has an effective support range, and the effective support ranges of at least two adjacent supporters of the plurality of supporters partially overlap with each other.

In some embodiments, the plurality of supporters are arranged in an array on the substrate.

In some embodiments, the backlight module further comprises an adhesive frame, the adhesive frame is between the substrate and the optical layer and arranged along four edges of the optical layer.

In some embodiments, the substrate comprises a plurality of light emitting elements arranged in an array, and the backlight module is a direct backlight module.

In some embodiments, a size of the backlight module is 34 inches, and the backlight module comprises twelve supporters arranged in three rows and four columns.

In some embodiments, a size of the backlight module is 34 inches, and the backlight module comprises twenty-one supporters arranged in three rows and seven columns.

According to another aspect of the present disclosure, a backlight module is provided, which comprises: a substrate; an optical layer on the substrate; and a plurality of supporters between the substrate and the optical layer. A spacing S between any two adjacent supporters among the plurality of supporters satisfies: S⁴≤K·|\vec{ω}|, where |\vec{ω}| is a vector, the modulus |\vec{ω}| of the vector is equal to the maximum allowable subsidence of the optical layer in a direction perpendicular to the substrate, and K is a positive number.

According to yet another aspect of the present disclosure, a display device is provided, which comprises: the backlight module described in any of the previous embodiments; and a display panel on a light emitting side of the backlight module.

### BRIEF DESCRIPTION OF THE DRAWINGS

Exemplary embodiments of the present disclosure will be described in detail with reference to the accompanying drawings, in which:

FIG. 1 shows a schematic diagram of a partial structure of a backlight module according to an embodiment of the present disclosure;

FIG. 2 shows a simplified schematic diagram of the structure and stress of the supporter and optical layer according to an embodiment of the present disclosure;

FIG. 3 shows a schematic diagram of the structure of an optical layer according to an embodiment of the present disclosure;

FIG. 4 shows a schematic diagram of the cross section of an optical layer according to an embodiment of the present disclosure;

FIG. 5 shows an arrangement of a plurality of supporters on a substrate according to an embodiment of the present disclosure;

FIG. 6 shows another arrangement of a plurality of supporters on a substrate according to an embodiment of the present disclosure; and

FIG. 7 shows a schematic diagram of the structure of a display device according to an embodiment of the present disclosure.

It should be understood that the drawings are only schematic illustrations of exemplary embodiments of the present disclosure, which are not limitations of the present disclosure and not necessarily drawn to scale. Moreover, in the drawings, the same or similar reference numerals in various drawings generally refer to the same or similar parts.

### DETAILED DESCRIPTION OF THE DISCLOSURE

The technical solutions in the embodiments of the present disclosure will be clearly described below with reference to the accompanying drawings. Obviously, the described embodiments are only some, but not all, of the embodiments of the present disclosure. Based on the embodiments of the present disclosure, all other embodiments obtained by those of ordinary skill in the art without undue experimentation fall within the scope of protection of this disclosure.

The direct backlight module has been increasingly applied to the display module including passive display panel because of its simple process, more uniform brightness and higher light efficiency utilization. The direct backlight module usually includes an optical layer and a substrate which are stacked. A plurality of light-emitting elements are arranged on a side of the substrate close to the optical layer, and an optical distance (OD) needs to be maintained between the substrate and the optical layer. The light emitted by the light-emitting elements can be fully mixed before irradiated into the optical layer, thus providing a surface light source with more uniform brightness everywhere.

In recent years, the industry has tried to reduce the production cost by reducing the number of light-emitting elements on the substrate. However, the reduction of the number of light-emitting elements will lead to the aggravation of the phenomenon of lamp shadow. The problem of light shadow can be effectively solved by increasing the optical distance. However, when the optical distance increases, that is, the distance between the optical layer and the substrate becomes larger, since the backlight module is usually in a flat state during production and transportation, if the optical distance between the optical layer and the substrate is realized only by means of a structure such as an adhesive frame arranged at four edges of the optical layer, the optical layer will be deformed due to gravity. With the increase of the size and/or weight of the optical layer, the deformation of the optical layer will become more and more serious. Thus, when the backlight module works in a vertical state, the optical quality of the outgoing light of the backlight module will be seriously affected. In order to avoid the deformation of the optical layer caused by gravity, a support structure may be introduced into the backlight module to provide support for the optical layer that is inevitably in the flat state during production and transportation. However, the inventor(s) of this application found that in the related art, the arrangement number and arrangement design of support structures in the backlight module completely depend on the experience of operators, and the number and/or arrangement design of support structures operated by different operators may vary greatly for the same backlight module, which makes the design of support structures lack of scientific theoretical basis and unable to achieve the optimal arrangement.

In view of this, some embodiments of the present disclosure provide a backlight module, in which the actual spacing between two adjacent supporters depends on the theoretical spacing obtained by fitting the actual theoretical calculation method. Arranging the actual spacing of supporters according to the theoretical spacing, the arrangement of the supporters is more scientific.

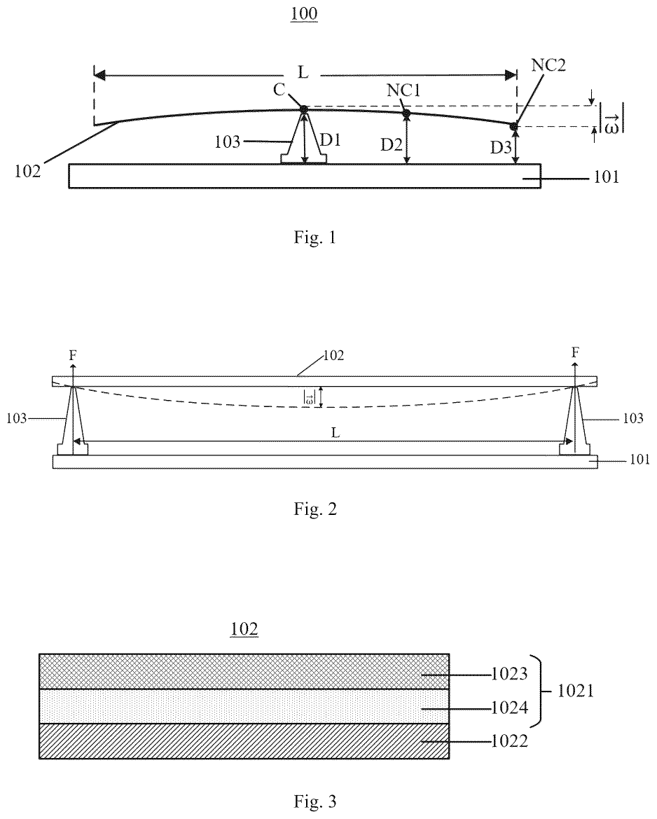

FIG. 1 shows a schematic diagram of a partial structure of a backlight module 100. As shown in FIG. 1, the backlight module 100 includes: a substrate 101; an optical layer 102 on the substrate 101; and a plurality of supporters 103 between the substrate 101 and the optical layer 102. Only a single supporter 103 is shown in FIG. 1 for simplicity. The optical layer 102 includes a contact area C that contacts with the supporter 103 and a non-contact area that does not contact with the supporter 103. As an example, two non-contact areas NC1 and NC2 are marked in FIG. 1, but in fact, as understood by those skilled in the art, the optical layer 102 may include countless non-contact areas. The distance between the contact area C and the substrate 101 is a first distance, the distance between the non-contact area and the substrate 101 is a second distance, and the first distance is greater than the second distance. In other words, the optical layer 102 is not completely flat with respect to the substrate 101. This is because, taking the supporter 103 as a center point, the farther away from the supporter 103, the greater the moment of the optical layer 102 due to its own weight, and the greater the subsidence of the optical layer 102 in the direction perpendicular to the substrate 101. Compared with the contact area C of the optical layer 102 that contacts with the supporter 103, the non-contact area of the optical layer 102 that does not contact with the supporter 103 collapses towards the direction close to the substrate 101, so that the optical layer 102 presents a shape like an “umbrella”.

The actual spacing S between any two adjacent supporters among the plurality of supporters satisfies S⁴≤K·|\vec{ω}|, where K is a positive number, \vec{ω} is a vector, the modulus |\vec{ω}| of the vector is equal to the maximum value of a difference between the first distance and the second distance, or, the modulus |\vec{ω}| refers to the maximum allowable subsidence of the optical layer 102 in a direction perpendicular to the substrate 101. For example, as shown in FIG. 1, the distance between the contact area C and the substrate 101 is the first distance D1, the distance between the non-contact area NC1 and the substrate 101 is the second distance D2, and the distance between the non-contact area NC2 and the substrate 101 is the second distance D3, the non-contact area NC2 is the position corresponding to the maximum subsidence of the optical layer 102. Therefore, the minimum value of the second distance is the second distance D3 between the non-contact area NC2 and the substrate 101. Thus, the maximum value |\vec{ω}| of the difference between the first distance and the second distance is equal to the difference between the first distance D1 and the second distance D3.

The embodiment of the present disclosure provides a theoretical calculation method for the spacing between two adjacent supporters 103. By making S⁴≤K·|\vec{ω}|, as long as the actual spacing S between two adjacent supporters 103 meets this condition, the optical layer 102 can be prevented from being excessively deformed, so that the deformation of the optical layer 102 is within the allowable range of optical requirements, and thus the optical quality of the outgoing light of the backlight module 100 can be improved.

Next, the theoretical basis for designing the actual spacing S between two adjacent supporters 103 will be described in more detail.

FIG. 1 can be regarded as a schematic diagram of the support range of a single supporter 103. As shown in FIG. 1, it is assumed that the optical layer 102 is placed on a single supporter 103, taking the supporter 103 as a center point, the farther away from the supporter 103, the greater the moment generated by the self-weight of the optical layer 102, and the greater the subsidence of the optical layer 102 in the direction perpendicular to the substrate 101, so that the optical layer 102 presents a shape like an “umbrella”. From the optical point of view, in order to ensure the picture uniformity of the display device including the backlight module 100, the amount of subsidence of the optical layer 102 in the direction perpendicular to the substrate 101 must be kept within a certain range. Assuming that the maximum allowable subsidence of the optical layer 102 in the direction perpendicular to the substrate 101 is |\vec{ω}|, the support range of a single supporter 103 can form a circle with a diameter of L with the maximum subsidence |\vec{ω}| as the boundary. In order to calculate the support range of a single supporter 103, two adjacent supporters 103 can be regarded as ball support points, and the supporter 103 only supports the optical layer 102 in the direction perpendicular to the substrate 101, without affecting the movement of the optical layer 102 in the direction parallel to the substrate 101. If a part of the optical layer 102 located between two adjacent supporters 103 is regarded as a crossbeam, the gravity G of the part of the optical layer 102 is regarded as a charge load with uniform distribution, and the supporter 103 provides a supporting force F for the optical layer 102, then the simplified structure and stress of the supporter 103 and the optical layer 102 of the backlight module 100 are shown in FIG. 2.

As can be seen from the simplified structure in FIG. 2, the structure satisfies the deflection equation:

$$\frac{M}{E \cdot {I}_{y}} = \frac{{d}_{\vec{ω}}^{2}}{{dx}^{2}} \qquad ( 1 )$$

In the formula (1), M represents the moment, and x is an arbitrary value between 0 and L.

From the formula (1), the following formula (2) can be obtained:

$$\vec{ω} = - \frac{[ ( {ρ}_{1} {h}_{1} + {ρ}_{2} {h}_{2} ) \cdot b \cdot α \cdot g ] \cdot x}{24 \cdot E \cdot {I}_{y}} \cdot ( {L}^{3} - 2 \cdot L \cdot {x}^{2} + {x}^{3} ) \qquad ( 2 )$$

The derivation process from the formula (1) to the formula (2) is as follows:

$$\frac{M}{E \cdot {I}_{y}} = \frac{{d}_{\vec{ω}}^{2}}{{dx}^{2}} \qquad ( 1 )$$

$$where , M = \frac{1}{2} ( {ρ}_{1} {h}_{1} \cdot ba + {ρ}_{2} {h}_{2} \cdot ba ) \cdot g \cdot x \cdot ( L - x ) = \frac{1}{2} QLx - \frac{1}{2} {Qx}^{2} ,$$

$$Q = ( {ρ}_{1} {h}_{1} \cdot ba + {ρ}_{2} {h}_{2} \cdot ba ) \cdot g .$$

E·I_{y}·\vec{ω}″=M·dx², performing mathematical integration, ∫E·I_{y}·\vec{ω}″=∫M·dx²,
obtaining

$$E \cdot {I}_{y} \cdot {\vec{ω}}^{′} = \frac{1}{4} {QLx}^{2} - \frac{1}{6} {Qx}^{3} + C \qquad ( I )$$

performing mathematical integration again,

$$\int E \cdot {I}_{y} \cdot {\vec{ω}}^{′} = \int ( \frac{1}{4} {QLx}^{2} - \frac{1}{6} {Qx}^{3} + C ) dx$$

obtaining

$$E \cdot {I}_{y} \cdot \vec{ω} = \frac{1}{12} {QLx}^{3} - \frac{1}{24} {Qx}^{4} + Cx + D \qquad ( II )$$

when

$$x = \frac{L}{2} , {\vec{ω}}^{′} = {θ}_{0} = 0 ,$$

substituting

$$x = \frac{L}{2}$$

into the formula (I) and getting

$$C = - \frac{1}{24} {QL}^{3} x = 0 , \vec{ω} = 0 ,$$

substituting X=0 and

$$C = - \frac{1}{24} {QL}^{3} .$$

into the formula (II) and getting D=0,
substituting

$$C = - \frac{1}{24} {QL}^{3} , \cdot D = 0 , \cdot Q = ( {ρ}_{1} {h}_{1} \cdot ba + {ρ}_{2} {h}_{2} \cdot ba ) \cdot g$$

into the formula (II) and getting

$$\cdot E \cdot {I}_{y} \cdot \vec{ω} = \frac{1}{24} ( {ρ}_{1} {h}_{1} \cdot ba + {ρ}_{2} {h}_{2} \cdot ba ) \cdot g \cdot x \cdot ( {L}^{3} - 2 L \cdot {x}^{2} + {x}^{3} )$$

$$so$$

$$\vec{ω} = - \frac{[ ( {ρ}_{1} {h}_{1} + {ρ}_{2} {h}_{2} ) \cdot b \cdot α \cdot g ] \cdot x}{24 \cdot E \cdot {I}_{y}} \cdot ( {L}^{3} - 2 L \cdot {x}^{2} + {x}^{3} ) \qquad ( 2 )$$

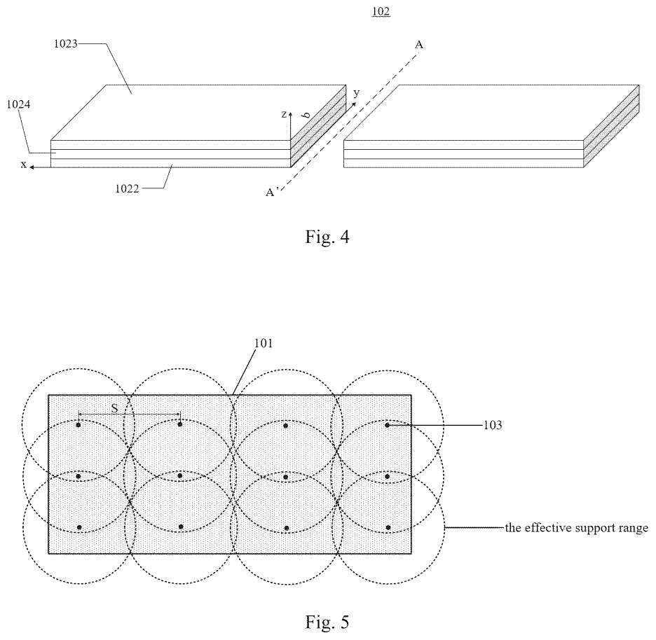

\vec{ω} is a vector, the specified positive direction is the direction from the substrate 101 to the optical layer 102, the negative sign after the equal sign in the formula (2) indicates that the direction of \vec{ω} is from the optical layer 102 to the substrate 101. The optical layer 102 includes a first optical layer and a second optical layer that are stacked. In the formula (2), ρ₁ is the density of the first optical layer and its unit is g/mm³; ρ₂ is the density of the second optical layer and its unit is g/mm³; h₁ is the thickness of the first optical layer and its unit is mm; h₂ is the thickness of the second optical layer and its unit is mm; E is the Young's modulus of the second optical layer and its unit is (g·m/s²)/mm²; g is the acceleration of gravity and its unit is m/s²; L is the theoretical spacing between two adjacent supporters 103 and its unit is mm; x is an arbitrary value between 0 and L and its unit is mm; α is the per unit length of the crossbeam in the simplified structure (i.e. the optical layer 102) along the first direction and its unit is mm, the first direction is parallel to the x axis and perpendicular to the z axis (i.e. the thickness direction of the optical layer 102) in the coordinate system, as shown in FIG. 4; b is the width of the crossbeam (i.e. the optical layer 102) in the simplified structure along the second direction and its unit is mm, the second direction is parallel to the y axis and perpendicular to the z axis in the coordinate system, as shown in FIG. 4; I_{y} is the moment of inertia of the cross section of the crossbeam (i.e. the optical layer 102) in the simplified structure along the line AA′ relative to the y axis and its unit is mm⁴, the cross section of the optical layer 102 is perpendicular to the plane where the substrate 101 is located, as shown in FIG. 4.

As shown in FIG. 3, in some embodiments, the optical layer 102 includes a first optical layer 1021 and a second optical layer 1022 that are stacked, and the second optical layer 1022 is closer to the substrate 101 than the first optical layer 1021. In some embodiments, the second optical layer 1022 is a diffusion plate, in such embodiments, ρ₂ in the formula (2) refers to the density of the diffusion plate, and h₂ refers to the thickness of the diffusion plate. The material of the diffusion plate includes but is not limited to polyethylene terephthalate (PET). In some embodiments, the first optical layer 1021 may include one or more layers. For example, the first optical layer 1021 may include a composite film 1023 and a quantum dot film 1024 that are stacked. In such an embodiment, ρ₁ in the formula (2) refers to the density of the composite film 1023 and the quantum dot film 1024, and h₁ refers to the total thickness of the composite film 1023 and the quantum dot film 1024. Materials of the composite film 1023 and the quantum dot film 1024 include but are not limited to polystyrene (PS). It can be understood that the composite film 1023 can have any of functions such as converging light at a specific angle (positive viewing angle), modifying various optical coupling phenomena, reducing or avoiding Newton's rings, reducing or avoiding interference fringes, reducing or avoiding black and white spots, and improving outgoing efficiency of light.

As mentioned above, I_{y} is the moment of inertia of the cross section of the crossbeam (i.e. the optical layer 102) in the simplified structure along the line AA′ relative to the y axis, as shown in FIG. 4, in some embodiments, the cross section may be rectangular in shape. I_{y} represents the bending strength of the optical layer 102. I_{y} can be expressed as:

$${I}_{y} = b \cdot \frac{{h}_{optical layer}^{3}}{12} \qquad ( 3 )$$

Since the layers of the optical layer 102 are usually stacked along the z axis direction, there is usually no connecting force between the layers. When the diffusion plate 1022 is bent, other layers located on the side of the diffusion plate 1022 away from the substrate 101 will be relatively displaced and bent, without increasing the bending strength of the diffusion plate 1022. Therefore, in the above simplified model, the bending strength is mainly provided by the diffusion plate 1022, so the moment of inertia of the cross section of the diffusion plate 1022 can be taken as the moment of inertia of the cross section of the entire optical layer 102. Therefore, the formula (3) can be expressed as:

$${I}_{y} = b \cdot \frac{{h}_{2}^{3}}{12} \qquad ( 4 )$$

In some embodiments, the thickness h₂ of the diffusion plate 1022 is 2.5 mm. Substituting h₂=2.5 mm into the formula (4) to get I_{y}=1.302b.

The value of b has no effect on the value of \vec{ω}. This is because, as can be seen from the formula (4), when the thickness h₂ of the diffusion plate 1022 is constant, the larger b is, the larger I_{y} is, so the larger the denominator in the formula (2) is. However, the larger b is, the larger the area of the cross section of the optical layer 102 along the line AA′ is, and the larger the weight G of the optical layer 102 is. Because G=(ρ₁h₁+p₂h₂)·b·α·g, the numerator in the formula (2) is accordingly larger. The increasing numerator and denominator cancel each other out, so that the value of \vec{ω} keeps constant. For example, suppose that an optical layer A and an optical layer B are provided, the width of the optical layer A in the second direction is b, and the width of the optical layer B in the second direction is b+Δb; the weight of the optical layer A is G, and G=(ρ₁h₁+ρ₂h₂)·b·α·g; the weight of the optical layer B is G+ΔG, and G+ΔG=(ρ₁h₁+ρ₂h₂)·(b+Δb)·α·g. The maximum subsidence of the optical layer A is denoted as \vec{ω₁} and the maximum subsidence of the optical layer B is denoted as \vec{ω₂}. According to the formula (2) and formula (4), then:

$$\begin{matrix}{\to }_{{ω}_{1}} = - \frac{[ ( {ρ}_{1} {h}_{1} + {ρ}_{2} {h}_{2} ) \cdot b \cdot α \cdot g ] \cdot x}{24 \cdot E \cdot b \cdot \frac{{h}_{2}^{3}}{12}} \cdot ( {L}^{3} - 2 \cdot L \cdot {x}^{2} + {x}^{3} ) \\ = - \frac{[ ( {ρ}_{1} {h}_{1} + {ρ}_{2} {h}_{2} ) \cdot α \cdot g ] \cdot x}{2 \cdot E \cdot {h}_{2}^{3}} \cdot ( {L}^{3} - 2 \cdot L \cdot {x}^{2} + {x}^{3} )\end{matrix}$$

$$\begin{matrix}{\to }_{{ω}_{2}} = - \frac{[ ( {ρ}_{1} {h}_{1} + {ρ}_{2} {h}_{2} ) \cdot ( b + Δ b ) \cdot α \cdot g ] \cdot x}{24 \cdot E \cdot ( b + Δ b ) \cdot \frac{{h}_{2}^{3}}{12}} \cdot ( {L}^{3} - 2 \cdot L \cdot {x}^{2} + {x}^{3} ) \\ = - \frac{[ ( {ρ}_{1} {h}_{1} + {ρ}_{2} {h}_{2} ) \cdot α \cdot g ] \cdot x}{2 \cdot E \cdot {h}_{2}^{3}} \cdot ( {L}^{3} - 2 \cdot L \cdot {x}^{2} + {x}^{3} )\end{matrix} .$$

As can be seen from the formulas of \vec{ω₁} and \vec{ω₂}, \vec{ω₁} and \vec{ω₂} have no relation with b, therefore, the change of value of b has no effect on the value of \vec{ω}.

In the formula (2), when x is equal to L/2, the modulus |\vec{ω}| of \vec{ω} is maximum. Substituting x=L/2 and

$${I}_{y} = b \cdot \frac{{h}_{2}^{3}}{12}$$

into the formula (2) to get

$${\to }_{ω} = - \frac{5 \cdot {L}^{4} \cdot [ ( {ρ}_{1} {h}_{1} + {ρ}_{2} {h}_{2} ) \cdot α \cdot g ]}{32 \cdot E \cdot {h}_{2}^{3}} \qquad ( 5 )$$

It can be known from the formula (5) that the theoretical spacing L between two adjacent supporters 103 satisfies the following equation:

$${L}^{4} = \frac{32 \cdot E \cdot {h}_{2}^{3}}{5 \cdot [ ( {ρ}_{1} {h}_{1} + {ρ}_{2} {h}_{2} ) \cdot g \cdot α ]} \cdot \vert \vec{ω} \vert \qquad ( 6 )$$

The theoretical spacing L is the maximum allowable spacing between two adjacent supporters 103. Therefore, in the backlight module 100, as long as the actual spacing S between two adjacent supporters 103 is less than or equal to the theoretical spacing L, the maximum subsidence |\vec{ω}| of the optical layer 102 is within the allowable range, so that the flatness of the optical layer 102 can be ensured within the allowable range, the optical quality of the outgoing light of the backlight module 100 can be improved, and the picture uniformity of the display device including the backlight module 100 can be improved.

It can be known from the formula (6) that

$${S}^{4} \leq {L}^{4} = \frac{32 \cdot E \cdot {h}_{2}^{3}}{5 \cdot [ ( {ρ}_{1} {h}_{1} + {ρ}_{2} {h}_{2} ) \cdot g \cdot α ]} \cdot \vert \vec{ω} \vert = K \cdot \vert \vec{ω} \vert ,$$

$$i . e . , K = \frac{32 \cdot E \cdot {h}_{2}^{3}}{5 \cdot [ ( {ρ}_{1} {h}_{1} + {ρ}_{2} {h}_{2} ) \cdot g \cdot α ]} .$$

The inventor(s) of the present application verified the 34-inch backlight module. The inventor(s) found that for the 34-inch backlight module, when the maximum subsidence |\vec{ω}| of the optical layer 102 is in the range of 0~0.35 mm, the picture uniformity of the display device is greater than 80%, which meets the design requirement. Substituting |\vec{ω}|=0.35 mm into the formula (6), to get the theoretical spacing L between two adjacent supporters 103 of the 34-inch backlight module, which is as the following formula (7):

$${L}^{4} = \frac{56 \cdot E \cdot {h}_{2}^{3}}{25 \cdot [ ( {ρ}_{1} {h}_{1} + {ρ}_{2} {h}_{2} ) \cdot g \cdot α ]} \qquad ( 7 )$$

In an exemplary example, the material of the composite film 1023 and the quantum dot film 1024 is polystyrene, and its density ρ₁ is 1.05 g/cm³. The material of the diffusion plate 1022 is polyethylene terephthalate, and its density ρ₂ is 1.39 g/cm³. The total thickness h₁ of the composite film 1023 and the quantum dot film 1024 is 0.72 mm, the thickness h₂ of the diffusion plate 1022 is 3 mm, the value of a is 1 mm, E is the Young's modulus of the diffusion plate 1022 and its value is 2900 MPa, g is the acceleration of gravity and its value is 9.8 m/s². It can be understood that in some embodiments, the composite film 1023 is a composite film with multiple functions. In some embodiments, the composite film 1023 may include a plurality of sub-layers stacked in sequence, for example, the composite film 1023 may include at least two of a diffusion sheet, a prism sheet, a brightness enhancement film and a brightness enhancement sheet. The base materials used by the plurality of sub-layers are the same, that is, they have the same density ρ₁. The thickness of the composite film 1023 is the sum of the thicknesses of the plurality of sub-layers.

Substituting the values of the above parameters into the formula (7), it can be concluded that the theoretical spacing L between any two adjacent supporters 103 among the plurality of supporters 103 is equal to 245.5 mm for the 34-inch backlight module. Therefore, when actually designing a 34-inch backlight module, as long as the actual spacing S between two adjacent supporters 103 is less than or equal to 245.5 mm, the maximum subsidence of the optical layer 102 will be less than or equal to 0.35 mm, and the picture uniformity of the display device will be greater than 80%, which meets the design requirement.

In the embodiments of the present disclosure, the support range theory of a single supporter 103 is put forward, the calculation method of the theoretical spacing L between two adjacent supporters 103 is deduced, and the actual spacing S between two adjacent supporters 103 is designed according to the theoretical spacing L. In this way, the design of the supporters 103 can depend on scientific theoretical basis, and the number of the supporters 103 in the backlight module 100 can be designed more reasonably, so as to realize the optimal arrangement. By making the actual spacing S between two adjacent supporters 103 less than or equal to the theoretical spacing L, the deformation of the optical layer 102 can be within the allowable range of optical requirements, thereby improving the optical quality of the outgoing light of the backlight module 100 and ensuring the picture uniformity of the display device. On the other hand, the plurality of supporters 103 are arranged depending on the theoretical spacing L, because the supporter 103 can ensure the flatness of the optical layer 102, the optical distance can be appropriately increased to overcome the problem of lamp shadow, which is helpful to reduce the number of light emitting elements on the substrate 101 and further to reduce the production cost.

The plurality of supporters 103 on the substrate 101 can be arranged according to the theoretical spacing L between two adjacent supporters 103. The arrangement of the plurality of supporters 103 should meet two conditions: (1) the number of supporters 103 should be as small as possible; (2) the effective support ranges of the plurality of supporters 103 can cover the entire optical layer 102.

FIG. 5 shows an arrangement of a plurality of supporters 103 on the substrate 101. In this arrangement, the actual spacing S between two adjacent supporters 103 among the plurality of supporters 103 is equal to the theoretical spacing L. For example, when the substrate 101 is a 34-inch substrate, the actual spacing S between two adjacent supporters 103 among the plurality of supporters 103 may be equal to 245.5 mm. A total of 12 supporters 103 are arranged on the substrate 101, and the 12 supporters 103 are arranged in an array on the substrate 101. The regular array arrangement is beneficial to making the effective support ranges of the plurality of supporters 103 cover the whole optical layer 102 better. In some embodiments, the 12 supporters are arranged in three rows and four columns on the substrate 101. According to the method for calculating the theoretical spacing between two adjacent supporters 103 provided by the embodiments of the present disclosure, only 12 supporters 103 are needed for a 34-inch backlight module, so that the entire optical layer 102 can be within the support ranges of the supporters 103, the flatness of the optical layer 102 can be ensured, and excessive collapse of the optical layer 102 can be prevented, thereby ensuring the optical quality of the outgoing light of the backlight module and improving the picture uniformity of the display device.

Referring to FIG. 5, each supporter 103 has an effective support range (the range shown by a dashed coil in FIG. 5), and the effective support ranges of at least two adjacent supporters 103 among the 12 supporters 103 partially overlap with each other. As shown in FIG. 5, in the horizontal direction, the effective support ranges of two adjacent supporters 103 only partially overlap; in the vertical direction, the effective support ranges of three adjacent supporters 103 only partially overlap with each other. In order to ensure that the entire optical layer 102 can be supported by the supporters 103, the effective support ranges of adjacent supporters 103 need to overlap. However, in order to ensure that the number of supporters 103 is as small as possible, the overlapping range of the effective support ranges of adjacent supporters 103 cannot be too large and cannot be completely overlapped, but only needs to be partially overlapped. In this way, on the premise of ensuring the flatness of the optical layer 102, the number of supporters 103 can be as small as possible. Reducing the number of supporters 103 is beneficial to more clearly observing the arrangement of the supporters 103 and the state of the optical layer 102, and is beneficial to the subsequent inspection and analysis of bad phenomena. In some embodiments, the effective support range of each supporter 103 is circular.

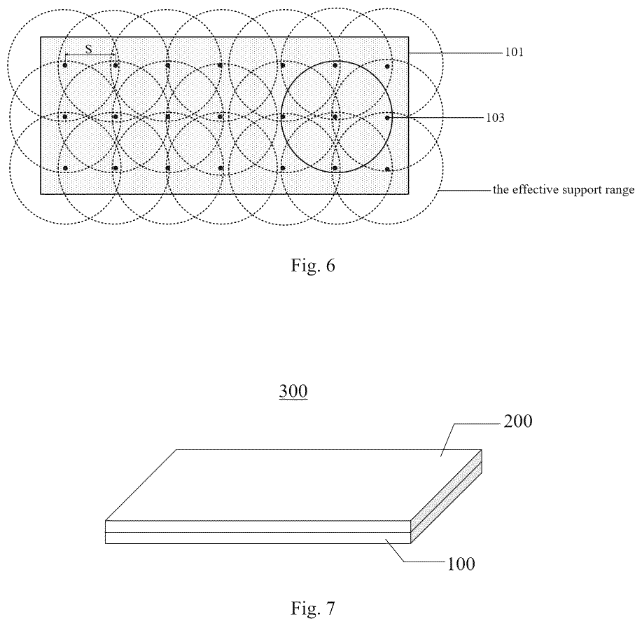

FIG. 6 shows another arrangement of a plurality of supporters 103 on the substrate 101. In this arrangement, the actual spacing S between two adjacent supporters 103 among a plurality of supporters 103 is less than the theoretical spacing L. Theoretically, the flatness of the optical layer 102 can be ensured as long as the actual spacing S between two adjacent supporters 103 is equal to the theoretical spacing L, but as known by those skilled in the art, in the preparation stage of the backlight module, it is necessary to carry out tests on the backlight module, such as vibration test and packaging material drop test, to ensure the product reliability of the backlight module. Because there is a certain gap between layers of the backlight module, during the vibration test and/or the packaging material drop test, the layers will vibrate in the z-axis direction, so the gravity and impact force of the layers will be transmitted to the substrate 101 on which a plurality of light-emitting elements are arranged through the supporters 103. If the number of supporters 103 is too small, the force transmitted to the substrate 101 by a single supporter 103 will be great, and the substrate 101 may be broken. Therefore, appropriately increasing the number of supporters 103 is beneficial to safely passing the vibration test and/or the packaging material drop test and preventing the substrate 101 from cracking. Therefore, when actually arranging the supporters 103 of the backlight module, at least the following two factors need to be considered: (1) the actual spacing S between two adjacent supporters 103 cannot be greater than the theoretical spacing L; (2) on the basis that the actual spacing S between two adjacent supporters 103 is not greater than the theoretical spacing L, in order to ensure the safety of passing the vibration test and/or packaging material drop test, the actual spacing S between two adjacent supporters 103 is appropriately reduced to appropriately increase the number of supporters 103.

In some embodiments, the actual spacing S between two adjacent supporters 103 is equal to half of the theoretical spacing L, that is,

$$S = \frac{L}{2} = \frac{{( K \cdot \vert \vec{ω} \vert )}^{\frac{1}{4}}}{2} .$$

For example, when the substrate 101 of FIG. 6 is a 34-inch substrate, the actual spacing S between two adjacent supporters 103 among the plurality of supporters 103 may be equal to 122.75 mm. Twenty-one supporters 103 may be arranged on the substrate 101, and the twenty-one supporters 103 are arranged in an array on the substrate 101, for example, in three rows and seven columns. The effective support ranges of the 21 supporters 103 can completely cover the area of the optical layer 102, ensuring the flatness of the optical layer 102. It is verified that this arrangement can safely pass the vibration test and the packaging material drop test of a single object.

This arrangement of the supporters 103 shown in FIG. 6 is beneficial to realizing the optimization of the arrangement of supporters 103, which can not only ensure the flatness of the optical layer 102, but also ensure that the backlight module can safely pass the vibration test and the packaging drop test of a single object, and ensure the reliability of the product.

In addition, the arrangement of the supporters 103 is limited not only by the theoretical spacing L between two adjacent supporters 103, but also by the equipment used to attach the supporters 103. The equipment used to attach the supporters 103 usually attaches the supporters 103 along the long side direction of the backlight module, so the plurality of supporters 103 are usually arranged in a rectangular shape.

For the backlight module with optical distance, in design, in order to avoid the risk that the edge of the substrate 101 cracks due to the excessive force transmitted to the substrate 101 due to the total weight of the optical layer 102 pressing on the supporters 103, in some embodiments, an adhesive frame is also arranged between the substrate 101 and the optical layer 102, and the adhesive frame is arranged along the four edges of the optical layer 102. In this way, the adhesive frame can support the optical layer 102 from the edges, and the supporters 103 otherwise arranged at the edge of the substrate 101 can move to the interior of the substrate 101 to avoid the edge of the substrate 101 from being cracked.

The substrate 101 may include a plurality of light-emitting elements arranged in an array, there is a gap between the substrate 101 and the optical layer 102, and the light emitted by the light-emitting elements is fully mixed in the gap and then irradiated into the optical layer 102 to provide a uniform light source, that is, the backlight module is a direct backlight module.

Each light emitting element may be a light emitting diode (LED), a Mini light emitting diode (Mini LED) or a Micro light emitting diode (Micro LED). Generally, the size of a Mini LED is about 100~300 μm, and the size of a Micro LED may be below 100 μm. Mini LED and Micro LED have many advantages, such as excellent display effect, light and thin volume, high contrast and long life, so they are increasingly used in the display field. For example, High-Dynamic Range (HDR) display can be realized by using Mini LED as the light-emitting element of the backlight module. When the backlight module is applied to a display device, the contrast of the display device can be significantly improved.

According to another aspect of the present disclosure, a backlight module 100 is provided, which comprises: a substrate 101; an optical layer 102 on the substrate 101; and a plurality of supporters 103 between the substrate 101 and the optical layer 102. A spacing S between any two adjacent supporters 103 among the plurality of supporters 103 satisfies S⁴≤K·|\vec{ω}|, where K is a positive number, \vec{ω} is a vector, and the modulus |\vec{ω}| of the vector is equal to the maximum allowable subsidence of the optical layer 102 in a direction perpendicular to the substrate 101.

FIG. 7 shows a schematic diagram of a display device 300 according to an embodiment of the present disclosure. As shown in FIG. 7, the display device 300 includes the backlight module 100 described in any of the previous embodiments, and a display panel 200 which is located at the light emitting side of the backlight module 100. The backlight module 100 provides a light source for the display panel 200 to display. In some embodiments, the display device 300 is a liquid crystal display device.

The display device 300 can have basically the same technical effect as the backlight module 100 described in the previous embodiments, so for the sake of brevity, the technical effect of the display device 300 is not repeated here.

It will be understood that although the terms first, second, third, etc. may be used herein to describe various elements, components, regions, layers and/or portions, these elements, components, regions, layers and/or portions should not be limited by these terms. These terms are only used to distinguish an element, component, region, layer or portion from another element, component, region, layer or portion. Thus, a first element, component, region, layer or portion discussed above could be termed a second element, component, region, layer or portion without departing from the teachings of the present disclosure.

Spatially relative terms such as “row”, “column”, “below”, “above”, “left”, “right”, etc. may be used herein for ease of description to describe factors such as the relationship of an element or feature to another element(s) or feature(s) illustrated in the figures. It will be understood that these spatially relative terms are intended to encompass different orientations of the device in use or operation in addition to the orientation depicted in the figures. For example, if the device in the figures is turned over, elements described as “below” other elements or features would then be oriented “above” other elements or features. Thus, the exemplary term “below” can encompass both an orientation of above and below. The device may be otherwise oriented (rotated 90 degrees or at other orientations) and the spatially relative descriptors used herein are interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to limit the present disclosure. As used herein, the singular forms “a,” “an,” and “the” are intended to comprise the plural forms as well, unless the context clearly dictates otherwise. It will be further understood that the terms “comprise” and/or “include” when used in this specification designate the presence of stated features, integers, steps, operations, elements and/or parts, but do not exclude the presence or addition of one or more other features, integers, steps, operations, elements, components and/or groups thereof. As used herein, the term “and/or” comprises any and all combinations of one or more of the associated listed items. In the description of this specification, description with reference to the terms “an embodiment,” “another embodiment,” etc. means that a particular feature, structure, material, or characteristic described in connection with the embodiment is included in at least one embodiment of the present disclosure. In this specification, schematic representations of the above terms are not necessarily directed to the same embodiment or example. Furthermore, the particular features, structures, materials or characteristics described may be combined in any suitable manner in any one or more embodiments or examples. Furthermore, those skilled in the art may combine the different embodiments or examples as well as the features of the different embodiments or examples described in this specification without conflicting each other.

It will be understood that when an element or layer is referred to as being “on”, “connected to”, “coupled to”, or “adjacent to” another element or layer, it may be directly on, directly connected to, directly coupled to, or directly adjacent to another element or layer, or intervening elements or layers may be present. In contrast, when an element is referred to as being “directly on”, “directly connected to”, “directly coupled to”, “directly adjacent to” another element or layer, with no intervening elements or layers present. However, in no case should “on” or “directly on” be interpreted as requiring a layer to completely cover the layer below.

Embodiments of the disclosure are described herein with reference to schematic illustrations (and intermediate structures) of idealized embodiments of the disclosure. As such, variations to the shapes of the illustrations are to be expected, e.g., as a result of manufacturing techniques and/or tolerances. Accordingly, embodiments of the present disclosure should not be construed as limited to the particular shapes of the regions illustrated herein, but are to comprise deviations in shapes due, for example, to manufacturing. Thus, the regions illustrated in the figures are schematic in nature and their shapes are not intended to illustrate the actual shape of a region of a device and are not intended to limit the scope of the present disclosure.

Unless otherwise defined, all terms (comprising technical and scientific terms) used herein have the same meaning as commonly understood by one of ordinary skill in the art to which this disclosure belongs. It will be further understood that terms such as those defined in commonly used dictionaries should be construed to have meanings consistent with their meanings in the relevant art and/or the context of this specification, and will not be idealized or overly interpreted in a formal sense, unless expressly defined as such herein.

As will be appreciated by those skilled in the art, although the steps of the methods of the present disclosure are depicted in a particular order in the figures, this does not require or imply that the steps must be performed in that particular order, unless the context clearly dictates otherwise. Additionally or alternatively, multiple steps may be combined into one step for execution, and/or one step may be decomposed into multiple steps for execution. Furthermore, other method steps may be inserted between the steps. The inserted steps may represent such as improvements of a method described herein, or may be unrelated to the method. Also, a given step may not be fully complete before the next step starts.

The above descriptions are merely specific embodiments of the present disclosure, but the protection scope of the present disclosure is not limited thereto. Any changes or substitutions that those skilled in the art can easily think of within the technical scope disclosed by the present disclosure, should be comprised within the protection scope of the present disclosure. Therefore, the protection scope of the present disclosure should be based on the protection scope of the claims.

1. A backlight module comprising:
a substrate;
an optical layer on the substrate; and
a plurality of supporters between the substrate and the optical layer,
wherein the optical layer comprises a contact area contacting with the plurality of supporters and a non-contact area not contacting with the plurality of supporters, and a first distance between the contact area and the substrate is greater than a second distance between the non-contact area and the substrate, and
wherein a spacing S between any two adjacent supporters among the plurality of supporters satisfies:
S⁴≤K·|\vec{ω}|,
where \vec{ω} is a vector, a modulus |\vec{ω}| of the vector is equal to a maximum value of a difference between the first distance and the second distance, and K is a positive number.

2. The backlight module according to claim 1, wherein
$$K = \frac{32 \cdot E \cdot {h}_{2}^{3}}{5 \cdot [ ( {ρ}_{1} {h}_{1} + {ρ}_{2} {h}_{2} ) \cdot g \cdot α ]} ,$$
where the optical layer comprises a first optical layer and a second optical layer that are stacked, ρ₁ is a density of the first optical layer and ρ₂ is a density of the second optical layer, h₁ is a thickness of the first optical layer and h₂ is a thickness of the second optical layer, α is a per unit length of the optical layer in a first direction, the first direction is parallel to an x axis of a coordinate system and perpendicular to a thickness direction of the optical layer, E is a Young's modulus of the second optical layer, and g is an acceleration of gravity.

3. The backlight module according to claim 1, wherein
$${\to }_{ω} = - \frac{[ ( {ρ}_{1} {h}_{1} + {ρ}_{2} {h}_{2} ) \cdot b \cdot α \cdot g ] \cdot x}{24 \cdot E \cdot {I}_{y}} \cdot ( {L}^{3} - 2 \cdot L \cdot {x}^{2} + {x}^{3} ) ,$$
where the optical layer comprises a first optical layer and a second optical layer that are stacked, ρ₁ is a density of the first optical layer and ρ₂ is a density of the second optical layer, h₁ is a thickness of the first optical layer and h₂ is a thickness of the second optical layer, α is a per unit length of the optical layer in a first direction, the first direction is parallel to an x axis of a coordinate system and perpendicular to a thickness direction of the optical layer, E is a Young's modulus of the second optical layer, g is an acceleration of gravity, b is a width of the optical layer in a second direction, the second direction is parallel to a y axis of the coordinate system and perpendicular to the thickness direction of the optical layer, I_{y} is a moment of inertia of a cross section of the optical layer relative to the y axis, the cross section of the optical layer is perpendicular to a plane where the substrate is located, L is a theoretical spacing between any two adjacent supporters among the plurality of supporters, and x is an arbitrary value between 0 and L.

4. The backlight module according to claim 3, wherein
$${I}_{y} = b \cdot \frac{{h}_{2}^{3}}{12}$$

5. The backlight module according to claim 3, wherein the first optical layer comprises a quantum dot film and a composite film, and the second optical layer comprises a diffusion plate.

6. The backlight module according to claim 1, wherein S≤245.5 mm.

7. The backlight module according to claim 1, wherein a range of |\vec{ω}| is 0~0.35 mm.

8. The backlight module according to claim 1, wherein the spacing S between any two adjacent supporters among the plurality of supporters satisfies:
$$S = \frac{{( K \cdot \vert \vec{ω} \vert )}^{\frac{1}{4}}}{2} .$$

9. The backlight module according to claim 1, wherein each supporter of the plurality of supporters has an effective support range, and the effective support ranges of at least two adjacent supporters of the plurality of supporters partially overlap with each other.

10. The backlight module according to claim 1, wherein the plurality of supporters are arranged in an array on the substrate.

11. The backlight module according to claim 1, further comprising:
an adhesive frame,
wherein the adhesive frame is between the substrate and the optical layer and arranged along four edges of the optical layer.

12. The backlight module according to claim 1, wherein the substrate comprises a plurality of light emitting elements arranged in an array, and the backlight module is a direct backlight module.

13. The backlight module according to claim 1, wherein a size of the backlight module is 34 inches, and the backlight module comprises twelve supporters arranged in three rows and four columns.

14. The backlight module according to claim 1, wherein a size of the backlight module is 34 inches, and the backlight module comprises twenty-one supporters arranged in three rows and seven columns.

15. A backlight module comprising:
a substrate;
an optical layer on the substrate; and
a plurality of supporters between the substrate and the optical layer,
wherein a spacing S between any two adjacent supporters among the plurality of supporters satisfies:
S⁴≤K·|\vec{ω}|,
where \vec{ω} is a vector, the modulus |\vec{ω}| of the vector is equal to a maximum allowable subsidence of the optical layer in a direction perpendicular to the substrate, and K is a positive number.

16. A display device comprising:
the backlight module according to claim 1; and
a display panel on a light emitting side of the backlight module.

17. The backlight module according to claim 15, wherein
$$K = \frac{32 \cdot E \cdot {h}_{2}^{3}}{5 \cdot [ ( {ρ}_{1} {h}_{1} + {ρ}_{2} {h}_{2} ) \cdot g \cdot α ]} ,$$
where the optical layer comprises a first optical layer and a second optical layer that are stacked, ρ₁ is a density of the first optical layer and ρ₂ is a density of the second optical layer, h₁ is a thickness of the first optical layer and h₂ is a thickness of the second optical layer, α is a per unit length of the optical layer in a first direction, the first direction is parallel to an x axis of a coordinate system and perpendicular to a thickness direction of the optical layer, E is a Young's modulus of the second optical layer, and g is an acceleration of gravity.

18. The backlight module according to claim 15, wherein
$${\to }_{ω} = - \frac{[ ( {ρ}_{1} {h}_{1} + {ρ}_{2} {h}_{2} ) \cdot b \cdot α \cdot g ] \cdot x}{24 \cdot E \cdot {I}_{y}} \cdot ( {L}^{3} - 2 \cdot L \cdot {x}^{2} + {x}^{3} ) ,$$
where the optical layer comprises a first optical layer and a second optical layer that are stacked, ρ₁ is a density of the first optical layer and ρ₂ is a density of the second optical layer, h₁ is a thickness of the first optical layer and h₂ is a thickness of the second optical layer, α is a per unit length of the optical layer in a first direction, the first direction is parallel to an x axis of a coordinate system and perpendicular to a thickness direction of the optical layer, E is a Young's modulus of the second optical layer, g is an acceleration of gravity, b is a width of the optical layer in a second direction, the second direction is parallel to a y axis of the coordinate system and perpendicular to the thickness direction of the optical layer, I_{y} is a moment of inertia of a cross section of the optical layer relative to the y axis, the cross section of the optical layer is perpendicular to a plane where the substrate is located, L is a theoretical spacing between any two adjacent supporters among the plurality of supporters, and x is an arbitrary value between 0 and L.

19. The backlight module according to claim 18, wherein
$${I}_{y} = b \cdot \frac{{h}_{2}^{3}}{12} .$$

20. The backlight module according to claim 18, wherein the first optical layer comprises a quantum dot film and a composite film, and the second optical layer comprises a diffusion plate.
